(19) United States
(12) Patent Application Publication
(10) Pub. No.: US 2007/0063984 A1
(43) Pub. Date: Mar. 22, 2007

(54) Input method for touch screen

(75) Inventor: Kuo Hua Chung, Taipei (TW)

Correspondence Address: BACON & THOMAS, PLLC, 625 SLATERS LANE, FOURTH FLOOR, ALEXANDRIA, VA, 22314, US

(73) Assignee: Primax Electronics Ltd., Taipei (TW)

(21) Appl. No.: 11/247,140

(22) Filed: Oct. 12, 2005

(30) Foreign Application Priority Data
Sep. 16, 2005 (TW) 094131966

(51) Int. Cl. G09G 5/00

(52) U.S. Cl. 345/173

(57) ABSTRACT

An input method for a touch screen is provided. The touch screen includes a virtual keyboard having a plurality of virtual keys. The method includes a step of displaying a possible key frame in response to the action of touching one of the virtual keys. The possible key frame includes a plurality of possible keys, which have relatively higher possibilities to be inputted after the one of the virtual keys is touched.

### FIELD OF THE INVENTION

The present invention relates to an input method, and more particularly to an input method for a touch screen.

### BACKGROUND OF THE INVENTION

Touch screens are widely used in handheld electronic devices, for example mobile phones and personal digital assistants (PDAs), as the interfaces for inputting data therevia.

Referring to FIG. 1, a schematic view of a conventional touch screen is illustrated. The touch screen 100 includes a virtual keyboard 101, which has a plurality of virtual keys 1011. The virtual keys 1011 include alphabetical keys, numeric keys, symbolic keys, function keys, etc. For example, by using a stylus to touch the virtual keys 1011, the designated letters in the English alphabet, symbols or functions are inputted via the touch screen 100.

As known, the inputting speed of using the virtual keyboard is much lower than that of using a real keyboard. By using the real keyboard, the ten fingers of the user are responsible for pressing respective specified keys. Even when the current key (e.g. the letter P) and the next key (e.g. the letter Q) to be pressed are far from each other, the user needs not shift one finger by a long distance. On the contrary, since only one stylus is used to touch the virtual keyboard, the time interval between two successive touch operations is relatively long. If the current key and the next key to be touched are far from each other, the user should shift the stylus by a larger distance. Consequently, the inputting speed of using the virtual keyboard is usually undesirable and the possibility of inputting wrong keys is increased.

In views of the above-described disadvantages, the applicant keeps on carving unflaggingly to develop an input method for a touch screen according to the present invention through wholehearted experience and research.

### SUMMARY OF THE INVENTION

It is an object of the present invention to provide an input method for a touch screen and a handheld electronic device using this input method, in which the inputting efficiency for the touch screen is increased and the possibility of inputting wrong keys is minimized.

In accordance with an aspect of the present invention, there is provided an input method for a touch screen. The touch screen comprises a virtual keyboard having a plurality of virtual keys. The method comprises a step of displaying a possible key frame in response to the action of touching one of the virtual keys. The possible key frame includes a plurality of possible keys, which have relatively higher possibilities to be inputted after the one of the virtual keys is touched.

In an embodiment, the possible key frame overlies the virtual keyboard.

In an embodiment, the possible key frame is a square frame containing nine possible keys.

In an embodiment, the virtual keyboard has the function for inputting letters in the English alphabet therevia, and the nine possible keys of the possible key frame include several alphabet keys and at least one symbolic key.

Alternatively, the possible key frame is a rectangular frame including the numeric keys 0˜9.

In accordance with another aspect of the present invention, there is provided a handheld electronic device. The handheld electronic device comprises a touch screen and an input control unit. The touch screen comprises a virtual keyboard having a plurality of virtual keys for inputting data therevia. The input control unit is used for displaying a possible key frame in response to the action of touching one of the virtual keys. The possible key frame includes a plurality of possible keys, which have relatively higher possibilities to be inputted after the one of the virtual keys is touched.

Preferably, the handheld electronic device is a mobile phone.

Preferably, the handheld electronic device is a personal digital assistant (PDA).

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view of a conventional touch screen;

FIG. 2 is a schematic view of a handheld electronic device with a touch screen according to a preferred embodiment of the present invention; and

FIGS. 3˜26 are schematic views of the touch screen illustrating the steps for inputting an English sentence according to the conventional input method and the input method of the present invention.

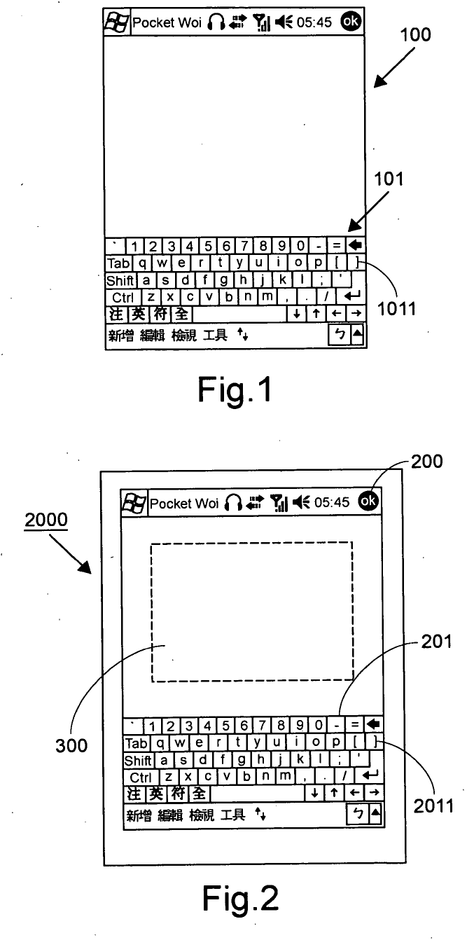

### DETAILED DESCRIPTION OF THE PREFERRED EMBODIMENT

Referring to FIG. 2, a schematic view of a handheld electronic device with a touch screen according to a preferred embodiment of the present invention is illustrated. An example of the handheld electronic device 2000 is a mobile phone or a personal digital assistant (PDA). The handheld electronic device 2000 comprises a touch screen 200 and an input control unit 300 mounted within the main body thereof. The touch screen 200 includes a virtual keyboard 201, which has a plurality of virtual keys 2011. The input control unit 300 controls implementation of the input method of the present invention.

Take the English alphabetical system for example. A single character is composed of one or more letters. According to a statistic result relating to 26,000 single characters in an English dictionary, five letters with the highest possibilities of occurrences following a specified letter at a specified position are reported in the following table.

| | | Five letters with the highest |
|---|---|---|
| | Specified | possibilities of occurrences |
| Position | Letter | following a specified letter |
| 1 | p | r, a, e, o, i |
| 1 | i | n, m, r, s, d |
| 1 | y | o, a, e, u, a |
| 1 | o | r, b, p, c, s |
| 2 | e | r, n, l, a, s |
| 2 | l | a, o, e, u, i |
| 2 | r | a, o, e, i, u |
| 2 | s | t, s, y, c, p |
| 3 | a | n, r, t, d, c |
| 3 | d | i, e, d, r, a |
| 3 | i | n, t, l, s, m |
| 4 | m | i, a, e, o, p |
| 4 | r | e, i, o, a, t |
| 5 | a | n, r, t, l, c |
| 5 | s | t, i, e, o, h |
| 6 | x | i, y, t, e |

From this statistic table with respect to the 26,000 single characters, the letters “p”, “i”, “y” and “o” have the highest possibilities of occurrences in the first position of the single characters. Whereas, the letters “e”, “l”, “r” and “s” have the highest possibilities of occurrences in the second position of the single characters. The rest may be deduced by analogy. On the other hand, the five letters with the highest possibilities of occurrences following the letter “p” are “r”, “a”, “e”, “o”, “i” if the letter “p” is located in the first position. Whereas, if the letter “i” is located in the first position, the five letters with the highest possibilities of occurrences following the letter “i” are “n”, “m”, “r”, “s” and “d”. The rest may be deduced by analogy. This statistic table is recorded in the handheld electronic device.

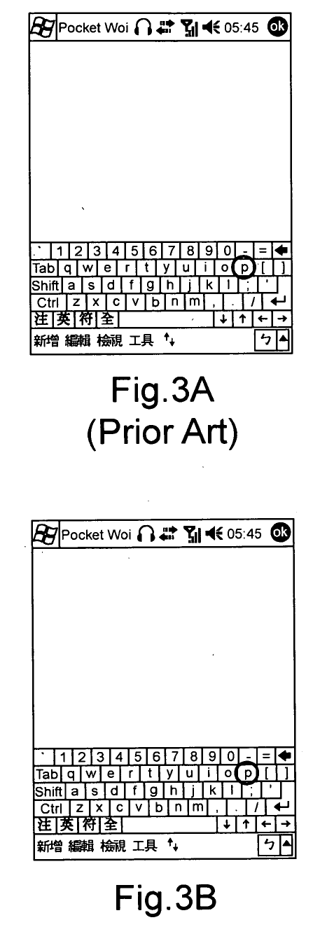

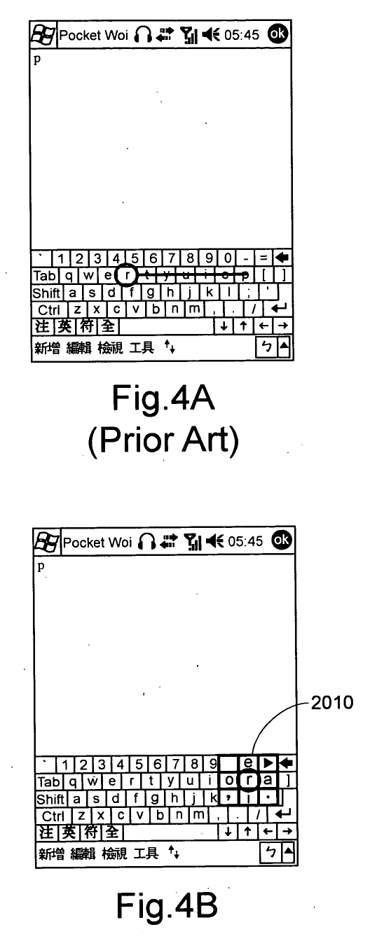

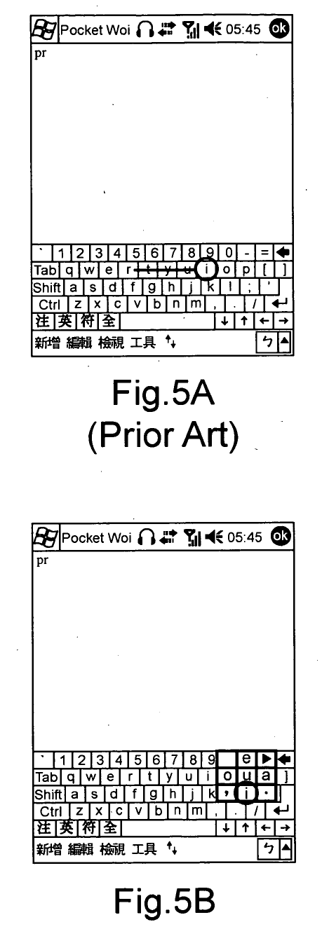

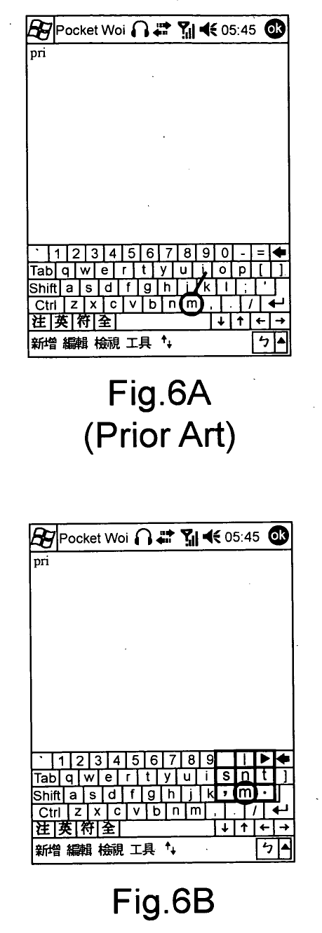

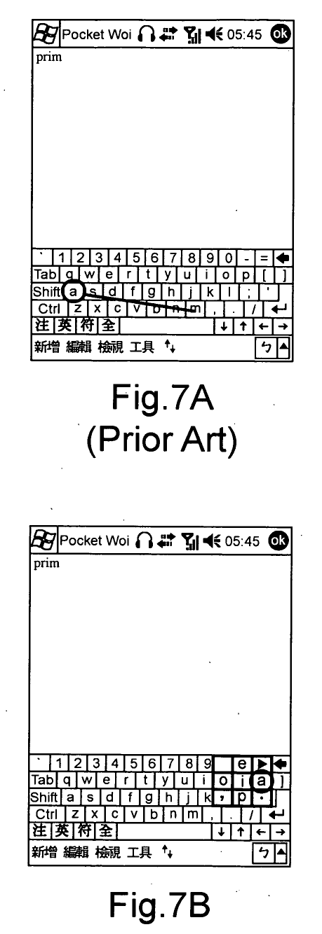

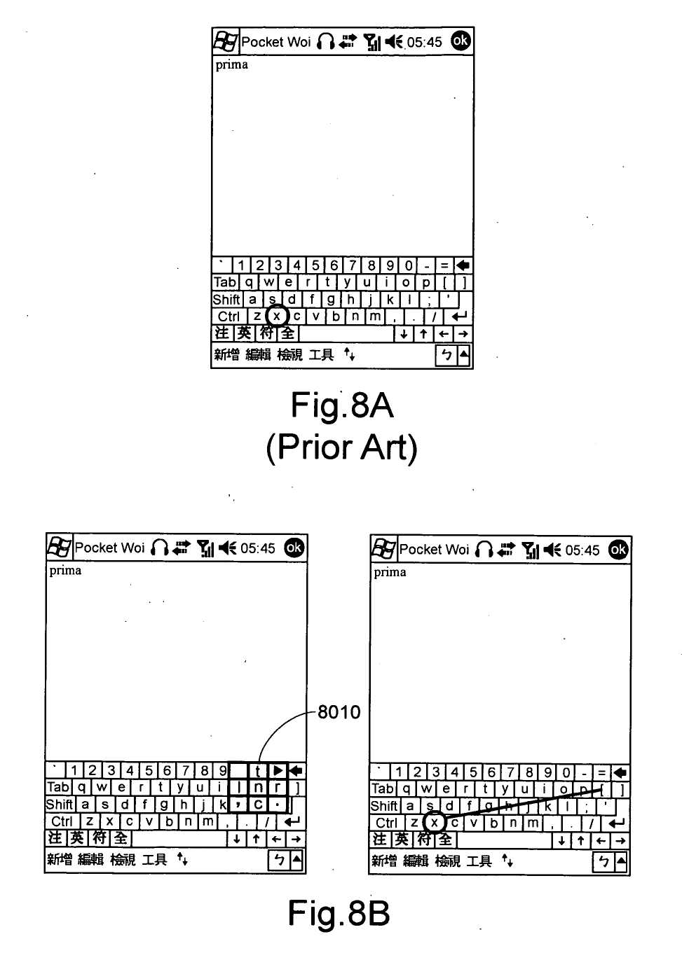

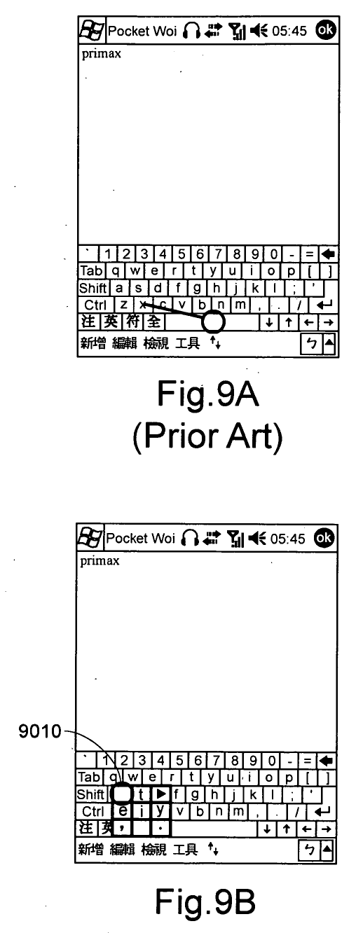

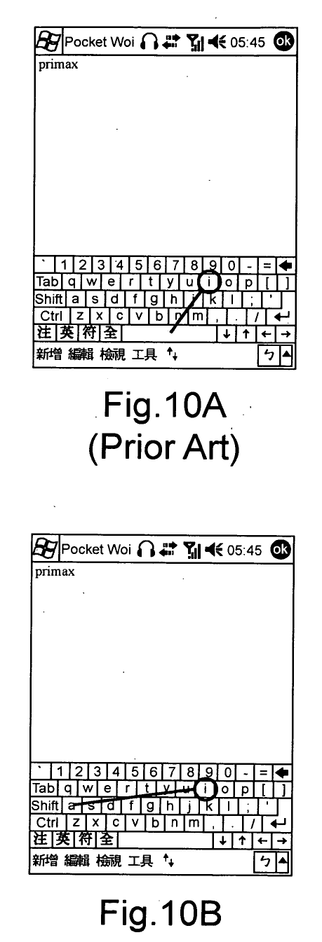

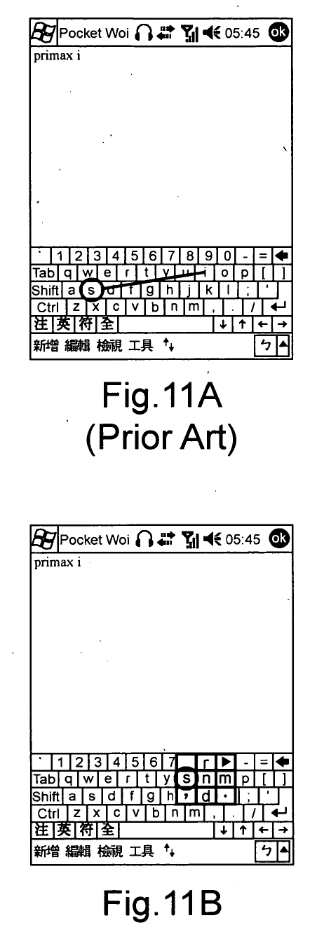

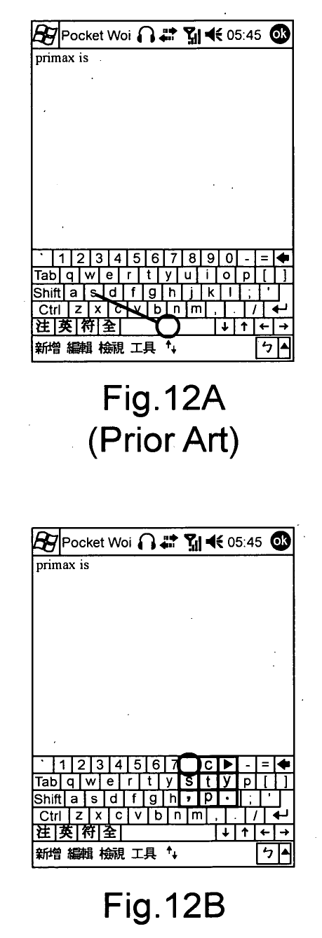

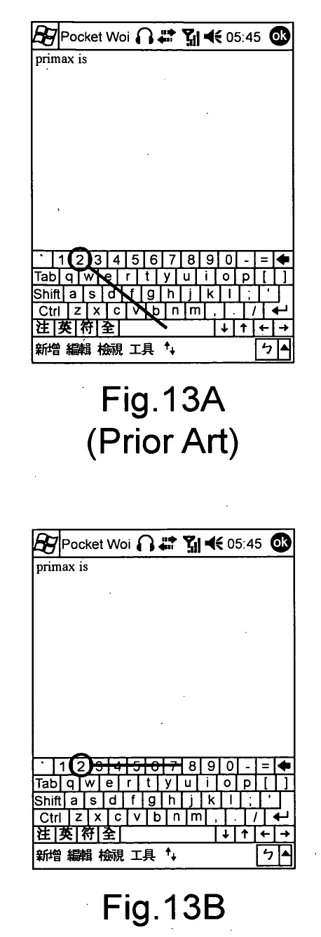

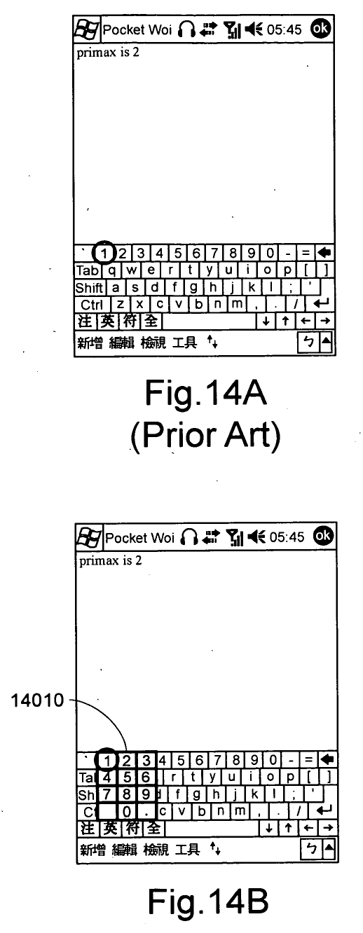

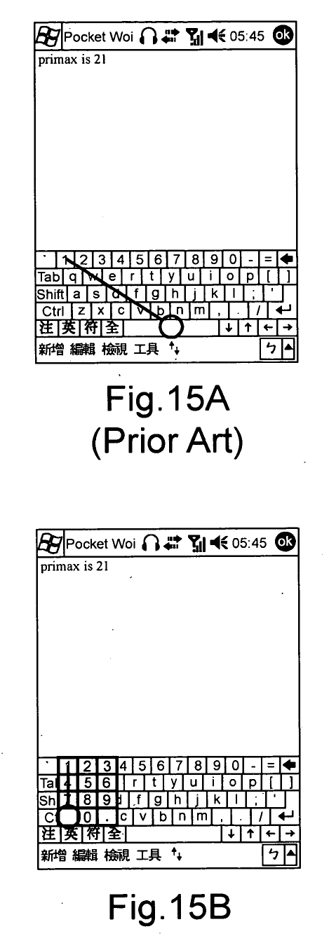

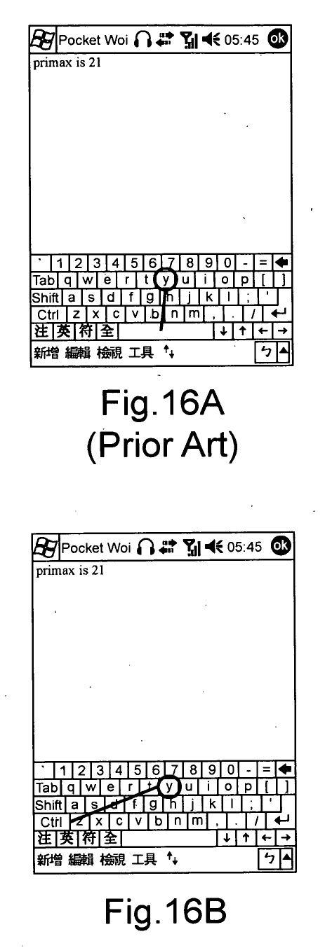

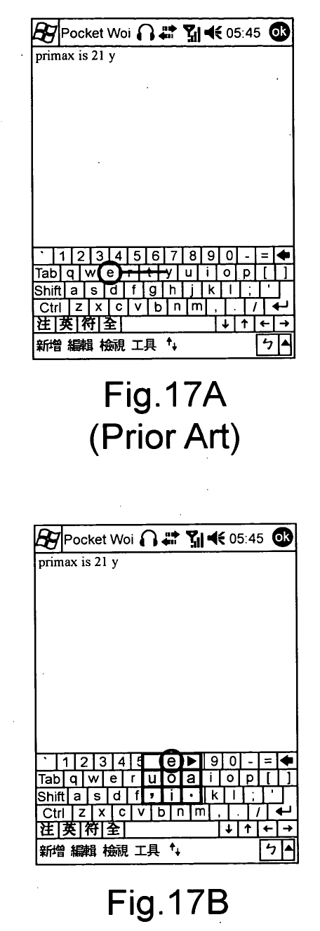

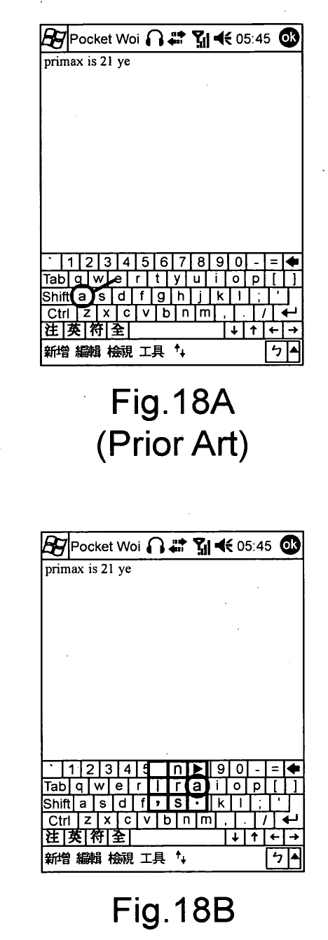

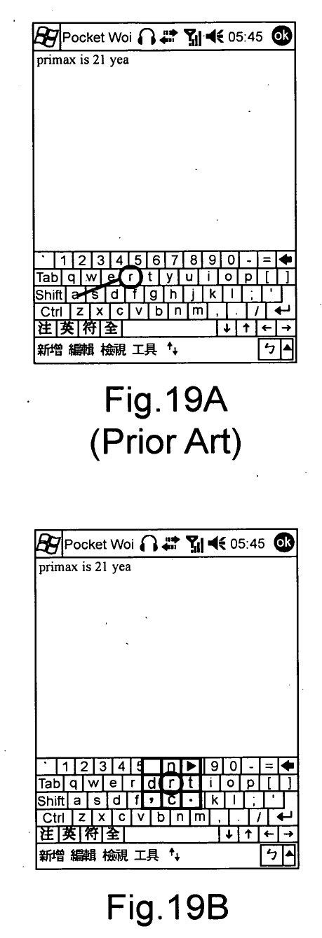

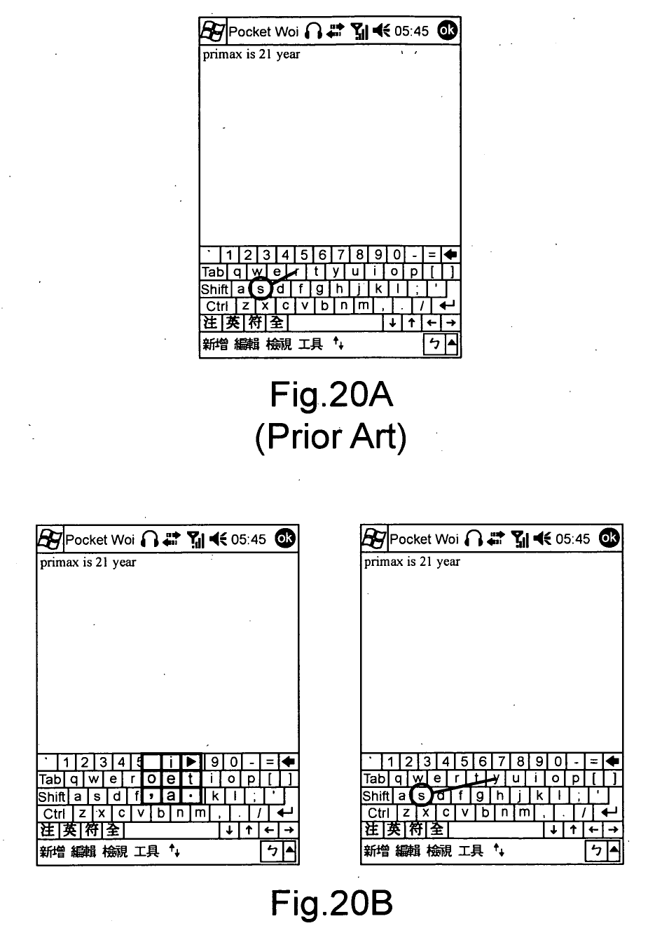

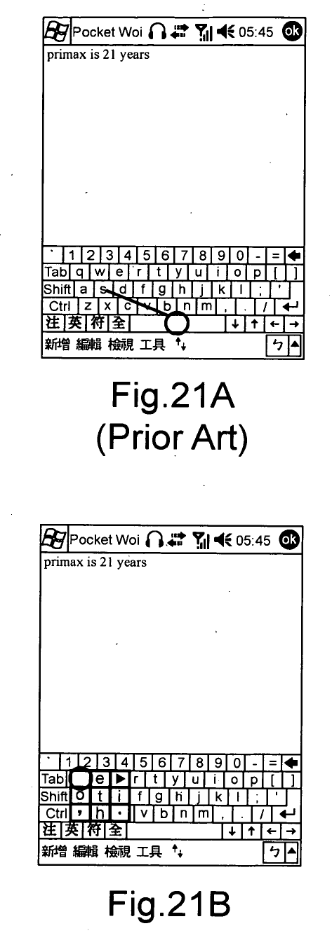

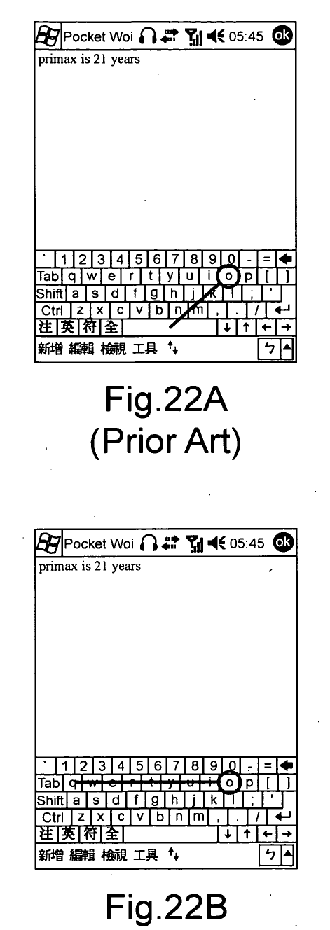

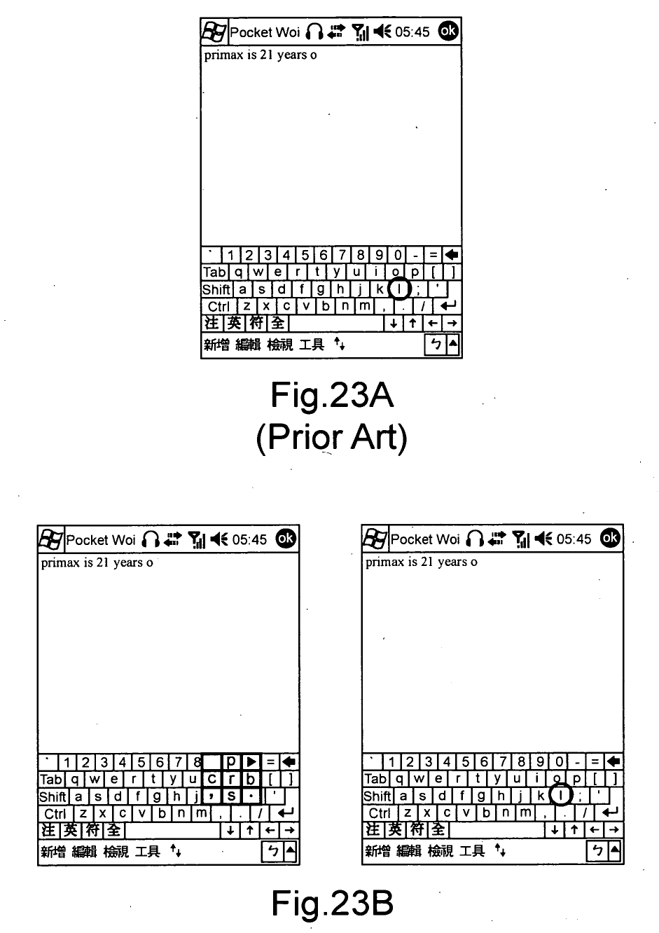

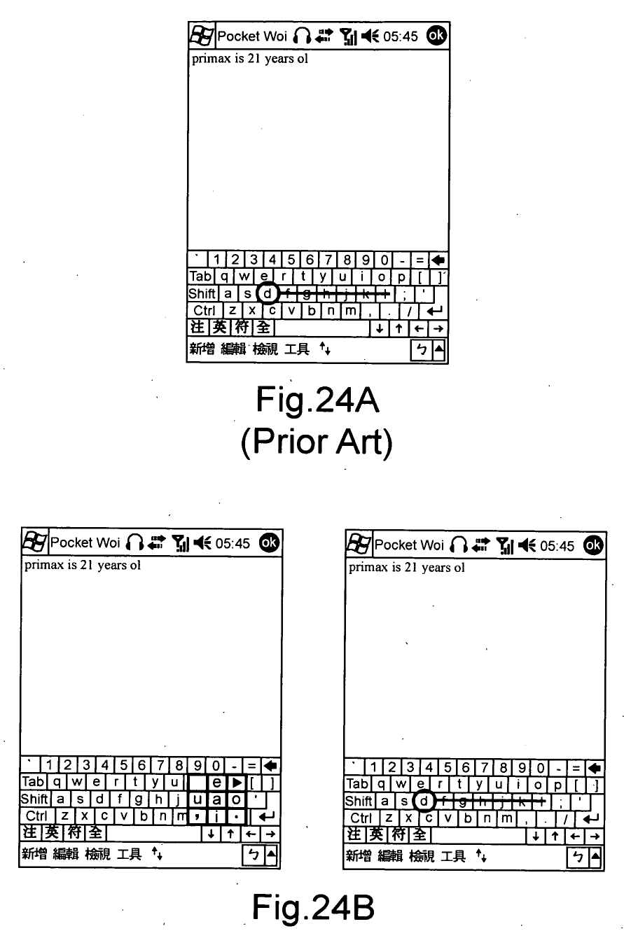

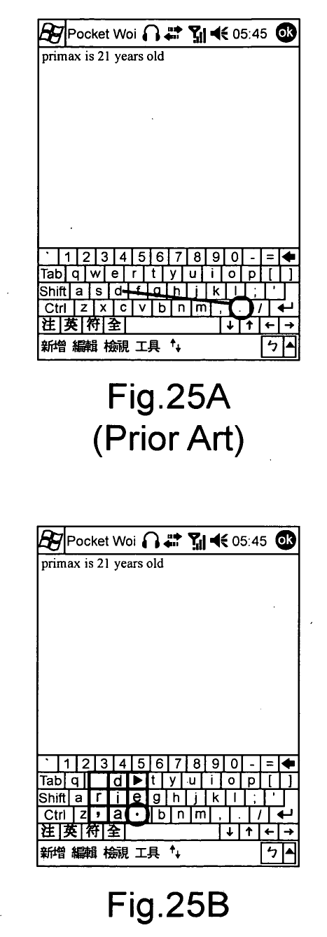

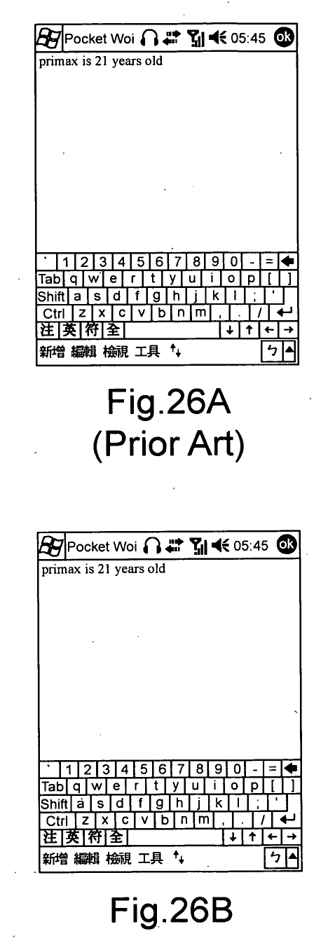

Hereinafter, for a purpose of comparison, the conventional input method for a touch screen and an embodiment of an input method according to the present invention will be illustrated with reference to FIGS. 3˜26, in which a sentence “Primax is 21 years old.” will be inputted into the handheld electronic device via the touch screen.

Please refer to FIGS. 3˜26. FIGS. 3A, 4A, 5A, . . . , 26A illustrate the conventional input method for a touch screen. Whereas, FIGS. 3B, 4B, 5B, . . . , 26B illustrate the input method for a touch screen according to the present invention.

Please refer to FIGS. 3A and 3B. The letter marked by the circle indicates the virtual key to be touched by the user. In a sentence “Primax is 21 years old.”, the first letter to be inputted is “p”.

Referring to FIGS. 4A and 4B, the next letter to be inputted is “r”. As shown in FIG. 4A, for a purpose of touching the letter “r”, the stylus should be moved from the virtual key p to the virtual key r, which means a long relative distance. According to the present invention, after the letter “p” is inputted, the input control unit 300 enables a possible key frame 2010 to be displayed and overlie on the touch screen, as is shown in FIG. 4B. The possible key frame 2010 displays nine possible virtual keys including the five letters with the highest possibilities of occurrences following the letter “p” (i.e. “r”, “a”, “e”, “o”, “i”), punctuation marks “,” and “.”, and a space key. Since some highly possible letters to be inputted are displayed on the possible key frame 2010 in response to the action of touching the letter “p”, the user can select the next letter “r” without difficulty because the distance for moving the stylus is largely reduced.

Please refer to FIGS. 5˜7. The letters “i”, “m” and “a” following the letter “r” are successively inputted according to the input methods similar to those described in FIGS. 4A and 4B, and are not to be redundantly described herein.

Referring to FIGS. 8A and 8B, the next letter to be inputted is “x”. As shown in FIG. 8A, for a purpose of touching the letter “x”, the stylus should be moved from the virtual key a to the virtual key x, which means a long relative distance. According to the present invention, after the letter “a” is inputted, the input control unit 300 enables a possible key frame 8010 to be displayed on the touch screen, as is shown in FIG. 8B. The possible key frame 8010 displays nine possible keys including the five letters with the highest possibilities of occurrences following the letter “a” (i.e. “n”, “r”, “t”, “l”, “c”), two punctuation marks “,” and “.”, and a space key. Since the letter “x” is not included in these highly possible letters displayed on the possible key frame 8010, the stylus should be moved from the possible key frame 8010 to the virtual key x in this situation.

By the way, the user can discriminate whether a desired letter is displayed on the possible key frame promptly because these nine possible keys are disposed within a rectangular area. Optionally, if no possible key in the possible key frame has been touched for a waiting time period, the input control unit 300 may close the possible key frame. The waiting time can be preset by the manufacturer or varied by the user. For example, the handheld electronic device may further include a testing mechanism for testing a suitable waiting time according to the user's requirement.

Referring to FIG. 9B, after the letter “x” is inputted, the input control unit 300 enables another possible key frame 9010 to be displayed on the touch screen. The possible key frame 9010 displays nine possible keys including the four letters with the highest possibilities of occurrences following the letter “a” (i.e. “i”, “y”, “t”, “e”), punctuation marks “,” and “.”, and two space keys. Since “x” is the last letter of the character “Primax”, the user can directly select a space key on the possible key frame 9010 in order to input the second character.

Referring to FIGS. 10A and 10B, the next letter to be inputted is “i”. Since the statistic data associated with the highest possibilities of occurrences following the space key are absent, the user should use the stylus to touch the virtual key i.

Please refer to FIGS. 11˜12. The letter “s” and the space key following the letter “i” are successively inputted to the touch screen according to the input methods similar to those described above, and are not to be redundantly described herein.

Referring to FIGS. 13A and 13B, the user can use the stylus to touch the virtual key “2” to input the number “2”.

Referring to FIGS. 14A and 14B, the next number to be inputted is “1”. According to the present invention, after the number “2” is inputted, the input control unit 300 enables another possible key frame 14010 to be displayed on the touch screen, as is shown in FIG. 14B. Statistically, following a specified number, the object with the highest possibility of occurrence is also a number. As a result, the possible key frame 14010 displays twelve possible keys including the numbers 0˜9, a punctuation marks “.” and a space key. Under this circumstance, the user can select the next number “1” from the possible key frame 14010.

Please refer to FIGS. 15A and 15B. Since “1” is the last number of the character “21”, the user can directly select a space key on the possible key frame 14010 in order to input the next character.

Please refer to FIGS. 16˜26. The other characters “years old.” are successively inputted according to the input methods similar to those described above, and are not to be redundantly described herein.

It is to be noted that the above descriptions of preferred embodiments of this invention are presented herein for purpose of illustration and description only. It is not intended to be exhaustive or to be limited to the precise form disclosed. The number and type of possible keys to be displayed on the possible key frames, for example the alphabetical keys, numeric keys, symbolic keys or function keys, may be designated according to the user's requirement.

From the above description, the input method of the present invention is advantageous for facilitating a user to promptly input the virtual keys displayed on the possible key frames without moving the stylus in a long relative distance. As a consequence, the inputting efficiency for the touch screen is increased and the possibility of inputting wrong keys is minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input method for a touch screen, said touch screen comprising a virtual keyboard having a plurality of virtual keys, said method comprising a step of displaying a possible key frame in response to the action of touching one of said virtual keys, wherein said possible key frame includes a plurality of possible keys, which have relatively higher possibilities to be inputted after said one of said virtual keys is touched.

2. The input method according to claim 1 wherein said possible, key frame overlies said virtual keyboard.

3. The input method according to claim 2 wherein said possible key frame is a square frame containing nine possible keys.

4. The input method according to claim 3 wherein said virtual keyboard has the function for inputting letters in the English alphabet therevia, and said nine possible keys of said possible key frame include several alphabet keys and at least one symbolic key.

5. The input method according to claim 2 wherein said possible key frame is a rectangular frame including the numeric keys 0˜9.

6. A handheld electronic device comprising:
a touch screen comprising a virtual keyboard having a plurality of virtual keys for inputting data therevia; and
an input control unit for displaying a possible key frame in response to the action of touching one of said virtual keys, wherein said possible key frame includes a plurality of possible keys, which have relatively higher possibilities to be inputted after said one of said virtual keys is touched.

7. The handheld electronic device according to claim 6 wherein said handheld electronic device is a mobile phone.

8. The handheld electronic device according to claim 6 wherein said handheld electronic device is a personal digital assistant (PDA).

9. The handheld electronic device according to claim 6 wherein said possible key frame overlies said virtual keyboard.

10. The handheld electronic device according to claim 9 wherein said possible key frame is a square frame containing nine possible keys.

11. The handheld electronic device according to claim 10 wherein said virtual keyboard has the function for inputting letters in the English alphabet therevia, and said nine possible keys of said possible key frame include several alphabet keys and at least one symbolic key.

12. The handheld electronic device according to claim 9 wherein said possible key frame is a rectangular frame including the numeric keys 0˜9.
